(19) United States
(12) Patent Application Publication
(10) Pub. No.: US 2004/0127108 A1
(43) Pub. Date: Jul. 1, 2004

(54) Male Terminal For a Lateral Insertion Connector

(75) Inventors: Santiago Ferre Giro, Tarragon Valls (ES); Salvador Alvarez, Tarragon Valls (ES)

Correspondence Address: Bruce E. Harang, PO BOX 872735, VANCOUVER, WA, 98687-2735, US

(73) Assignee: Lear Corporation, Southfield, MI (US)

(21) Appl. No.: 10/707,333

(22) Filed: Dec. 5, 2003

(30) Foreign Application Priority Data
May 31, 2002 (WO) 02/097924

(51) Int. Cl. H01R 9/24

(52) U.S. Cl. 439/891

(57) ABSTRACT

Improved plug tap terminal for side insertion connector, constituted of a cable terminal structure composed of a holding base from which a connection plug and a cable guiding small channel protrude from each one of its two ends.

### DETAILED DESCRIPTION

The present invention, improved plug tap terminal for side insertion connector, consists of an improvement in the cable terminals currently used for these type of connectors with special features, important advantages or benefits being derived from its special structure which enable easily and quickly carrying out said type of electric connections, a very important question in determined sectors, such as that of electric assemblies in the automobile industry.

As a result, the present invention will be of special interest for the manufacturing and supply sector of electric installation equipment, especially that which is dedicated to the auxiliary automobile industry.

The plug tap terminals currently used in said type of side insertion connectors fundamentally differ because both the plug tap terminals and the socket terminals were traditionally introduced into the connector body on the upper part, as well as on the lower part thereof, at the openings corresponding to said cavities, both being electrically and mechanically connected inside, in turn being retained in said cavities by the normally used corresponding mechanical means.

Said side insertion connectors have evolved in the Art such that the cavities regularly arranged inside thereof are provided with terminal retention means, such that once these are placed in their functional position, they can neither shift nor move as a result of having a single side base.

As a result, precisely for being applied in said type of connectors, its is necessary to propose terminals with a special structure, specifically designed to be inserted in the improved side insertion connector, protected by Utility Model 9900772, in a mechanism enabling the connection of the connector in its housing by means of a reduction of the necessary efforts for carrying out said operation.

As a result of this, the present invention, improved plug tap terminal for side insertion connector, consists of a cable terminal structure constituted of a holding base from which a connection plug and a cable guiding small channel protrude from each one of its two ends. Furthermore, said holding base is formed by a prismatic structure provided with side and horizontal windows for holding by means of flaps provided in the fixing mechanism in the connector, susceptible to withstanding forces in both directions that are transversal to the longitudinal axis of the terminal.

Likewise, the shape of the connection plug of said terminal also adopts a prismatic profile with straight walls that are parallel to the longitudinal axis. In this manner, the shape of said connection plug also contributes to securing the terminal inside of said side insertion connector.

On the other hand, said small channel is constituted of one or several curve steps joined together for channeling the cable towards said horizontal window through which it enters to the inside of said terminal holding base, inside of which the electric connection with a plug or connection element occurs.

A detailed description of the improved anchoring device for terminal boxes in services boxes, object of the present invention, will be made below with reference to the accompanying drawings, in which a preferred embodiment form is shown as a non-limiting example, susceptible to all those variations in detail which imply no fundamental alteration of the essential features of said improvements.

Said drawings show:

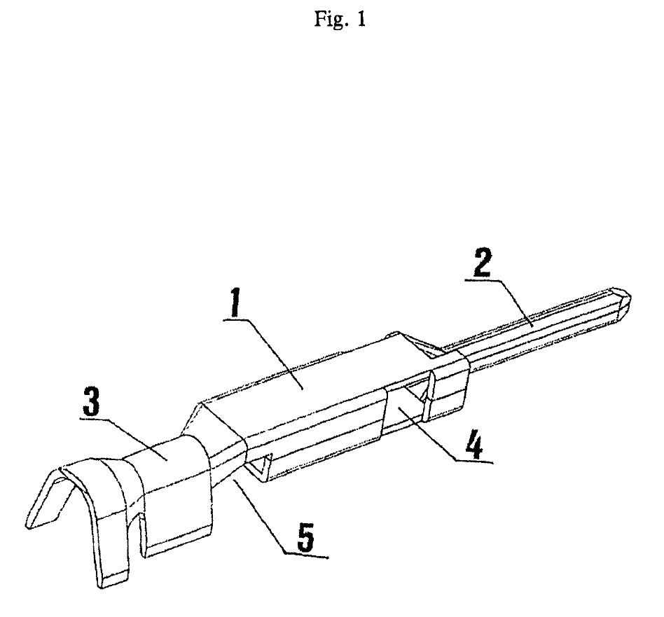

FIG. 1 shows a perspective view of the improved plug tap terminal for side insertion connector.

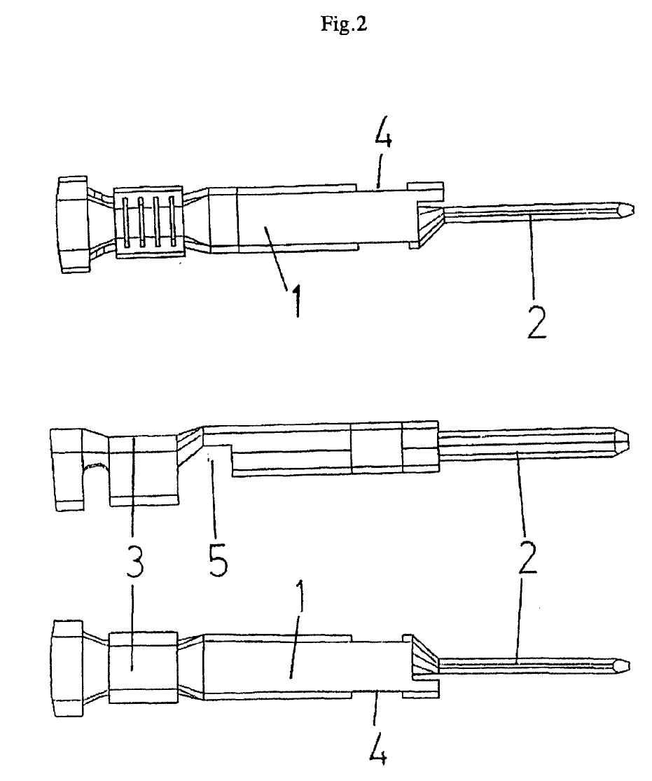

FIG. 2 shows side and plan views of the improved plug tap terminal for side insertion connector.

According to the presented embodiment example, the improved plug tap terminal for side insertion connector shown in this preferred embodiment form, is fundamentally constituted of a cable terminal structure constituted of a holding base (1) from which a connection plug (2) and a cable guiding small channel (3) protrude from each one of its two ends. Furthermore, said holding base (1) is formed by a prismatic structure provided with side windows (4) and horizontal windows (5) for holding by means of flaps provided in the fixing mechanism in the connector, susceptible to withstanding forces in both directions that are transversal to the longitudinal axis of the terminal.

Likewise, the shape of the connection plug (2) of said terminal also adopts a prismatic profile with straight walls that are parallel to the longitudinal axis. In this manner, the shape of said connection plug (2) also contributes to securing the terminal inside of said side insertion connector.

On the other hand, said small channel (3) is constituted of one or several curve steps joined together for channeling the cable towards said horizontal window (5) through which it enters to the inside of said terminal holding base (1), inside of which the electric connection with the plug (2) or connection element occurs.

Finally, the shape, materials and dimensions can vary, and, generally, all that is accessory and secondary, as long as it does not alter, change or modify the essential improvements that have been disclosed.

1. Improved plug tap terminal for side insertion terminal, constituted of a cable terminal structure constituted of a holding base (1) from which a connection plug (2) and a cable guiding small channel (3) protrude from each one of its two ends, characterized in that said holding base (1) is formed by a prismatic structure provided with side windows (4) and horizontal windows (5) for holding by means of flaps that have been foreseen in the fixing mechanism in the connector, susceptible to withstanding the forces in both directions that are transversal to the longitudinal axis of the terminal.

2. Improved plug tap terminal for side insertion terminal according to claim 1, characterized in that the shape of the connection plug (2) of said terminal also adopts a prismatic profile with straight walls that are parallel to the longitudinal axis.

3. Improved plug tap terminal for side insertion terminal according to any of the previous claims, characterized in that said small channel (3) is constituted of one or several curve steps joined together for channeling the cable towards said horizontal window (5) through which it enters to the inside of said terminal holding base (1), inside of which the electric connection with the plug (2) or connection element occurs.
